(19) United States
(12) Patent Application Publication
(10) Pub. No.: US 2005/0238764 A1
(43) Pub. Date: Oct. 27, 2005

(54) Food packaging having a shaped lid part

(75) Inventor: Stefan Beese, Winsen/Luhe (DE)

Correspondence Address: MORRISON & FOERSTER LLP, 1650 TYSONS BOULEVARD, SUITE 300, MCLEAN, VA, 22102, US

(73) Assignee: Omni-Pac Ekco GmbH & Co., Hamburg (DE)

(21) Appl. No.: 10/524,106

(22) PCT Filed: Aug. 13, 2003
(86) PCT No.: PCT/EP03/09000

§ 371 Date: Feb. 10, 2005

(51) Int. Cl. C12C 1/027

(52) U.S. Cl. 426/106

(57) ABSTRACT

A foodstuffs packaging unit includes a bottom part which has at least one row of shaped depressions for accommodating separate articles, in particular eggs, and a lid part which is arranged for swing action on the bottom part. When the lid part is closed, it bounds an interior together with the bottom part. The lid part includes a trough which is open upwardly and a cover that closes off the trough in an upward direction to produce a space into which items can be inserted. The packaging may also include retaining depressions which are connected to one another by the trough. The retaining depressions may be designed as clamping openings that interact with clamping elevations on the underside of the shaped depressions of another foodstuffs packaging unit.

The invention relates to foodstuffs packaging, in particular an egg box, having a bottom part, which has at least one row of shaped depressions for accommodating separate articles, in particular eggs, and having a shaped lid part, which is arranged for swing action on the bottom-part and, in the closed state, bounds an interior together with the bottom part, the lid part having a trough which is open in the upward direction.

Egg boxes which comprise a bottom part, for accommodating the eggs, and a protective lid part, which is arranged for swing action on the bottom part via an element which is usually configured as a flexible hinge, are known from prior public use. In order to accommodate the eggs, the bottom part is provided with shaped depressions which serve for retaining the eggs in a certain position in relation to the egg box. Such an egg box is known, for example, from FR-A-2441549. In order to increase the reliability of the packaging, the lid part may be provided with depressions. These have a stiffening effect and serve for the improved absorption of loads which act on the lid part. The depressions of the lid part, moreover, often also serve for stabilizing the positions of the eggs accommodated therein. Such egg packaging is known, for example, from EP-A-0119043. In addition to the egg box protecting the eggs packaged in it against damage during transportation and storage, the egg box has to perform a further function, namely that of presentation. Alongside the protective function, this presentation function is becoming increasingly important. It is the presentation function which is responsible for the impression which the customer has of the goods.

An egg box in which the lid part has a trough which is open in the upward direction is also known from prior public use. This trough is configured such that its flanks have large through-passages to the interior of the egg box. This trough is thus unsuitable for accommodating any items.

The object of the invention is to provide foodstuffs packaging of the type mentioned in the introduction in the case of which both the protective function and the presentation function are improved.

The object is achieved according to the invention by foodstuffs packaging having the features of claim 1. Advantageous developments can be gathered from the subclaims.

In the case of foodstuffs packaging having a bottom part, which has at least one row of shaped depressions for accommodating separate articles, in particular eggs, and having a shaped lid part, which is arranged for swing action on the bottom part and, in the closed state, bounds an interior together with the bottom part, the lid part having a trough that is open in the upward direction, said lid part having a covering means that closes off the trough in the upward direction, the invention provides that said trough has dimensions for accommodating items and that said covering means is designed such that dropping out of the item is prevented. The term “open in the upward direction” here is to be understood as meaning that, in the closed state of the lid part, the trough is accessible from the outside.

The essence of the invention is that the trough and the covering means produce a space into which items can be inserted safely. The covering means prevents the inserted item from dropping out of the trough in an undesired manner. For this purpose, the covering means is designed such that, in conjunction with the trough, it forms a closed-off accommodating space and is designed sufficiently solid, in order to prevent the item pushing through. The flanks on the base of the trough preferably have no through-passages or only through-passages with an inside width which is small enough in order to prevent the articles which are to be inserted from passing through in an undesired manner. The articles which are to be inserted have preferably already been inserted by the supplier of the foodstuffs packaging, but it is also possible, if appropriate, for them only to be inserted during packaging of the foodstuffs or, at a later stage, by a retailer. The item may be, for example, leaflets containing recipes or else small utensils, in particular a child's toy, an egg spoon and/or a portion pack containing herbs and spices. The foodstuffs packaging then provides the customer not just with the foodstuffs contained in it but also, as an added extra, with the item inserted into the trough. In addition to its securing function, the covering means also has a further, important function. The user must first remove the covering means from the trough in order to reach the item located therein. This puts the user in a cheerful state of expectation as to what he is going to find beneath the covering means, this being similar to the sense of surprise when unwrapping presents. Since the user already knows when he purchases the foodstuffs that he will later experience this pleasant sense of surprise, he already regards the foodstuffs packaging in a favourable light as he is making the decision to purchase it. The foodstuffs packaging according to the invention thus performs the important function of packaging to a particularly great extent, that is to say in addition to protecting the goods contained in it, it also encourages the customer to make a purchase.

The covering means is preferably a sticker. The trough can thus be covered in a particularly cost-effective manner. Moreover, the sticker provides a printing surface which can be utilized for further presentation purposes or for other advertising imprints. The covering means is preferably arranged pulled around two opposing edges of the lid part. That enhances the safety of the fastening and the aesthetic impression.

It is expedient if the lid part is provided with retaining depressions, which are preferably connected to the trough. The retaining depressions additionally stiffen the lid part. Moreover, they may be shaped such that they interact with the top side of the articles, e.g. eggs, packaged in the foodstuffs packaging. This makes it possible to prevent undesired movement of the eggs in the shaped depressions even when the foodstuffs packaging is being moved quickly, e.g. during transportation. If the trough is connected to the retaining depressions, then this has the advantage that a considerably larger accommodating space is produced at the same time as the rigidity of the lid part is further increased.

The trough and the retaining depressions expediently are approximately the same depth. As a result, the floors of the respective depressions are located at the same height so that, overall, they form a planar surface. On the one hand, this has the advantage of providing the lid part, and thus the foodstuffs packaging as a whole, with a more pleasing appearance than would be the case with different depths and the resulting crevice-containing structure of the floor. It is also possible for the trough to have a greater depth than the retaining depressions, with the result that, in the accommodating space—which is formed by the trough and the retaining depressions connected to it—a channel forms in the region of the trough. On the one hand such a channel may be quite desirable for the items which are to be inserted. On the other hand, the channel additionally has a stiffening effect, with the result that the rigidity of the lid part is yet further improved.

The trough and/or the retaining depressions preferably have/has a depth which is no greater than a maximum nesting height of the foodstuffs packaging. Limiting the depth to the maximum nesting height improves the stackability of the foodstuffs packaging unit in the open, not yet filled state. A particular advantage resides in the fact that it is also possible for he foodstuffs packaging units to be stacked when the trough has already been closed by the covering means. This is advantageous in particular in the case where the covering means is a sticker, for example a label. It is then also possible for already labelled foodstuffs packaging units to be stacked. This allows the foodstuffs packaging units to be labelled, and provided with the items which are to be inserted, before being filled. The maximum nesting height depends on the concrete parameters of the respective foodstuffs packaging, in particular the desired denesting capability and the amount of space required. Depending on the material thickness and the coefficient of friction of the material, the nesting height is usually between 4 and 15 mm, and is preferably between 7 and 9 mm. By virtue of the stackability thus achieved in the open state, the storage costs decrease both for the manufacturer and for the packaging company and packaging can take place more cost-effectively.

The retaining depressions are preferably offset laterally in relation to the shaped depressions. Offset laterally means that the retaining depressions in the lid part, rather than being arranged precisely over the respective shaped depressions of the base part, are offset horizontally, with the result that a retaining depression is arranged approximately in the centre over two adjacent depressions in a row. In the case of the offset arrangement, a smaller number of retaining depressions is sufficient for acting on all of the articles packaged in foodstuffs packaging. For example, in the case of an egg box for six eggs, four retaining depressions are then sufficient. For further stiffening of the retaining depressions, it may be expedient if the retaining depressions have an indent on their floor. This indent may be curved concavely or preferably convexly, i.e. in the upward direction. The shaped depressions may be provided at their bottom border with an annular structure as indent. An annular structure of toric design, with the result that a toric recess forms, has proven particularly successful. On account of its shape, it has increased elasticity in this region, by means of which the packaged foodstuffs are protected particularly well against damage by impact, for example by being set down with force. Such indents thus improve not just the protective function but also, in addition, the overall visual impression given by the foodstuffs packaging.

In the case of a particularly preferred embodiment, which possibly also merits independent protection, the bottom part and the lid part are provided with complementary clamping elevations and clamping openings. Foodstuffs packaging units stacked one above the other can be connected to one another in a force-fitting manner by the clamping elevations and openings. This is not just favourable for storing filled foodstuffs packaging units, but, in particular, provides advantages in respect of a subsequent use for the foodstuffs packaging units. The foodstuffs packaging usually has no further function than that of protecting the eggs contained therein; once used up, the foodstuffs packaging is thrown away. The invention makes a second use for the foodstuffs packaging possible. This is because the complementary clamping elevations and openings allow the foodstuffs packaging units, which are empty following use, to be used as clamping-type building blocks. It is thus possible for the foodstuffs packaging units according to the invention, once they have performed their packaging function, also to be used as a toy. They are suitable, in particular for forming comparatively large structures, for example toy castles for children, which, using conventional-type building blocks can only be produced with comparatively high outlay, if at all, since the conventional clamping-type building blocks are considerably smaller. In contrast, the foodstuffs packaging units according to the invention are comparatively large and make it possible for even large structures to be constructed rapidly. Moreover, they are available at more or less no cost.

The arrangement of the clamping elevations and clamping openings according to the invention, furthermore, has the advantage that the stackability of the foodstuffs packaging units in the open state remains unaffected. The packaging units can still be stacked, and if appropriate also easily destacked, in the open state. In order that this destacking (denesting) takes place straightforwardly, the clamping elevations and/or clamping openings are preferably respectively no higher or deeper than a maximum nesting height. The nesting height is usually between 4 and 15 mm, and is preferably between 7 and 9 mm.

It is preferable, in the closed state of the lid part, for the clamping openings, rather than being arranged precisely over the clamping elevations on the shaped depressions, to be arranged approximately centrally over two adjacent clamping elevations in a row. As a result, the clamping elevations only engage in the clamping openings when the foodstuffs packaging units are not stacked precisely one above the other. In the case of the stacking directly one above the other which usually takes place in sales racks, the clamping openings and the clamping elevations thus do not engage one inside the other. This avoids the foodstuffs packaging units getting stuck together in the sales rack. This effectively counteracts the risk of the entire stack being tipped over in an undesired manner when the uppermost box is removed. The offset arrangement of the clamping elevations and clamping openings, furthermore, has advantages for the use of the foodstuffs packaging units as clamping-tight building blocks, because it is easier to produce offset structures as a result. The foodstuffs packaging units can easily be interconnected in order for it thus to be possible to construct stable corner connections or wall sections running over relatively long distances.

For the better interconnection of a plurality of foodstuffs packaging units, the top edge of the lid part is expediently configured such that its spacing from the nearest clamping opening is, at most, equal to the free spacing between adjacent clamping elevations. Free spacing is understood as being the clear distance between two adjacent clamping elevations. This configuration ensures that the clamping elevations of a foodstuffs packaging unit placed on top engage either in the retaining depressions on the lid part or engage on the far side of the top edge of the lid part. This avoids the situation where clamping elevations rest on the top side of the lid part, as a result of which a correct clamping fit would be prevented.

The clamping elevations and clamping openings expediently have a conicity of 2° to 15°, preferably of 7° to 9°. On the one hand, such a conicity makes it possible to achieve a good level of reliability for the clamping connection; on the other hand, however, it also allows sufficiently easy separation of the foodstuffs packaging units, without an excessive amount of force having to be applied for this purpose. This applies, in particular, to the denesting of foodstuffs packaging units stacked in the open state.

At least six clamping elevations, arranged in a double row, are preferably provided. It goes without saying that a corresponding number of clamping openings, e.g. four, then also have to be provided. This number makes it possible to achieve a stable clamping-type interconnection of a plurality of foodstuffs packaging units of course, it is also possible to provide eight or more clamping elevations.

It is expedient here for the retaining depressions to be designed as clamping openings and for the shaped depressions to be designed as clamping elevations. For example, the shaped depressions may be provided with a bottom border which is dimensioned such that it engages in a force-fitting manner in the clamping openings. This allows the foodstuffs packaging unit to be designed as a clamping-type building block with only a small amount of additional outlay.

The invention is explained in more detail hereinbelow with reference to the egg boxes illustrated in the drawing as exemplary embodiments. In the drawing:

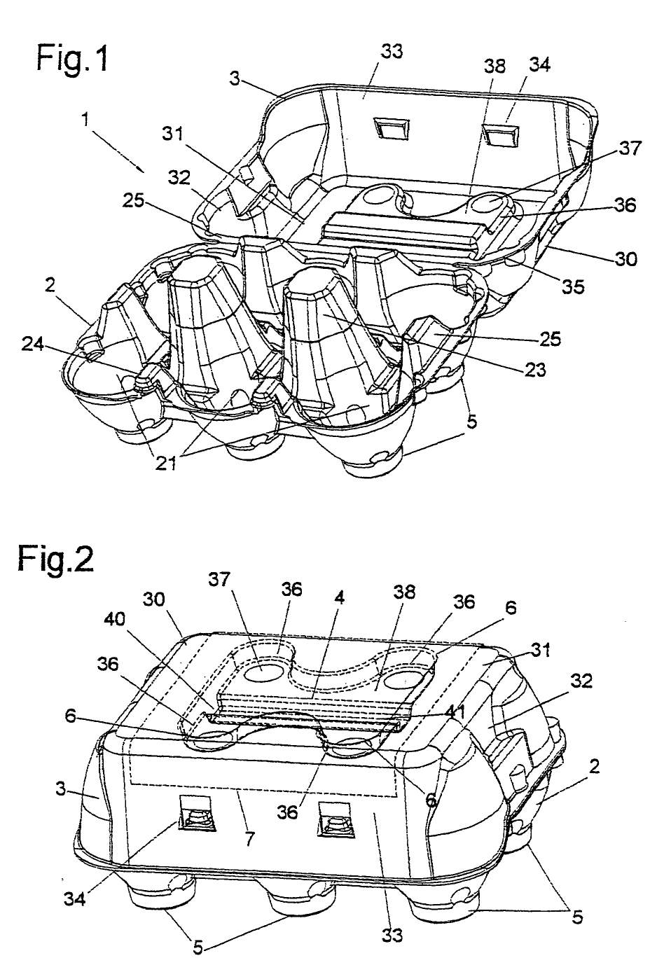

FIG. 1 shows a perspective view of a first exemplary embodiment of the egg box according to the invention in the open state;

FIG. 2 shows a perspective view of the egg box according to FIG. 1 in the closed state;

FIG. 3 shows the egg box according to the invention; and

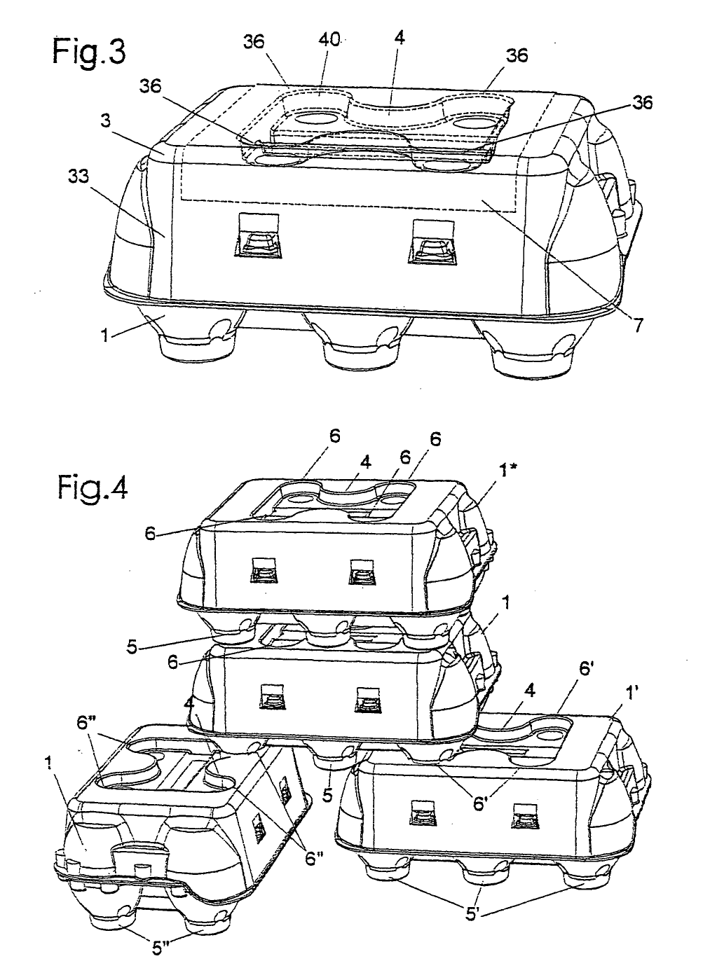

FIG. 4 shows a plurality of egg boxes according to a second exemplary embodiment in clamping-type interconnection with one another.

An egg box according to the invention is illustrated in the swung-open state in FIG. 1 and in the closed state in FIG. 2. The egg box, which is designated 1 overall, comprises a bottom part 2 and a lid part 3, which is fastened for swing action on the bottom part 2 via a flexible hinge 25, and a sticker 7 fitted on said lid part (see FIG. 3). In the closed state, the lid part 3 rests on the bottom part 2 and covers over the latter completely. Pivoting the lid part 3 through approximately 180° about the axis of the flexible hinge 25 moves the lid part 3 into its open position. In the latter, the lid part 3 is located approximately in the same plane as the base part 2. In this position, a plurality of egg boxes can be stacked in a space-saving manner.

The base part 2 has a plurality of shaped depressions 21 for accommodating eggs. In the exemplary embodiment illustrated, the shaped depressions 21 are arranged in two parallel rows of in each case three shaped depressions 21. These shaped depressions 21 are formed by a corresponding configuration of the wall of the base part 2 and by two supports 23 arranged in the centre. The shaped depressions are configured such that eggs inserted therein do not come into contact with one another. In order to fix the lid part 3 in the closed state, two retaining noses 24 are arranged on a front side of the base part 2.

The lid part 3 is of tray-like configuration and comprises a rear part, a top part 31, two side parts 32 and a front part 33. The front part 33 contains two openings 34, which are intended for interacting with the noses 24 for the base part 2 in order to lock the lid part 3, in the closed state, to the base part 2. In the closed state, the lid part 3, together with the base part 2, bounds an interior in which the eggs are arranged in a protected manner.

The configuration of the top part 31 of the lid part 3 can be seen in more detail in FIG. 2. The top part 31 is enclosed by a top edge 30. The top part 31 is provided with four retaining depressions 36. The retaining depressions 36 are offset in relation to the shaped depressions 21 of the base part 2, to be precise such that, in the closed state of the egg box 1, the retaining depressions 36 are arranged centrally in each case over two shaped depressions 21 which are directly adjacent to one another in a row. In the case of the egg box 1 with six shaped depressions 21 which is illustrated in the exemplary embodiment, four retaining depressions 36 are thus arranged in the top part 31 of the lid part 3. The retaining depressions 36 each have a floor 38 containing a convexly upwardly curved recess 37. The recess 37 serves for stiffening the floor 38 of the retaining depression 36. By way of the border of the floor 38, each of the retaining depressions 36 has a stabilizing effect on the top side of the eggs arranged in the adjacent rows of shaped depressions 21. It is not absolutely necessary, for this purpose, for the eggs to come into contact with the border of the floor 38 when inserted; in particular in the case of relatively small eggs, this is often not the case. The function of the retaining depression 36 is, rather, to limit undesired movement of the top side of the eggs. This makes it possible to avoid damage by way of eggs in adjacent shaped depressions 11 striking against one another as a result of abrupt and rough handling of the egg box. The retaining depressions 36 also serve for additionally stiffening the lid part 3. The egg box 1 can thus better protect the packaged eggs against damage. Moreover, the stacking capability of the egg box 1 improves as a result.

A trough 4 is arranged approximately in the centre of the top part 31 of the lid part 3. The trough 4 is oriented parallel to the axis of the flexible hinge 25 and extends over at least half of the lid part 3, in the example illustrated over approximately ¾ of the length. In the exemplary embodiments illustrated, it connects all four retaining depressions 36 to one another. This produces a receiving space 40 which, as seen from above, is in the form of a rounded letter “H”. In the case of the exemplary embodiment illustrated in FIG. 2, a floor 41 of the trough 4 is located at a lower level than the floor 38 of the retaining depressions 36. This produces a central channel within the accommodating space 40. It goes without saying that the floor 41 of the trough 4 may also be located at a higher level than the floor 38 of the retaining depressions 36. In the case of the exemplary embodiment illustrated in FIG. 4, the floor 41 is located at the same height as the floor 38 of the retaining depressions 36. The accommodating space 40, which is produced by the retaining depressions 36 being connected to the trough 4, is comparatively large. It is suitable for accommodating both elongate items and items of irregular configuration, for example a bottle opener, by way of its widened end. The length of the trough 4 is expediently selected such that the item which is to be accommodated can be conveniently inserted therein. It is not imperative for the length to be predetermined by the spacing of the retaining depressions 36; it may also be selected to be longer or shorter, depending on the respective requirements. In order for it to be possible for egg boxes which are stacked in the open state to be easily separated from one another, the flanks of the trough 4 and of the retaining depression 36 are inclined in relation to the vertical. The degree of inclination depends on the material properties, in particular the material thickness and the coefficient of friction, and is usually between 2° and 20°, preferably between 6° and 9°. This allows the stacked egg boxes to be destacked again in optimum fashion, i.e. a good denesting capability is achieved.

In order to avoid the situation where the item inserted into the accommodating space 40 drops out during transportation, a sticker 7 is provided. The latter is adhesively bonded to the top part 31 of the lid part 3 such that it extends over the four retaining depressions 36 and the trough 4, with the result that the entire accommodating space 40 is covered by the sticker 7. However, the sticker 7 serves not just for preventing the inserted item from dropping out. It also has the function of hiding from the user's view the item which has been inserted into the accommodating space 40. As a result, it is only when he tears off the sticker 7 from the lid part 3 of the egg box 1 that the user knows what kind of item is hidden behind it in the accommodating space 40. This achieves a very much desirable sense of surprise, and the user is left with a greater and more positive impression of the egg box. The sticker 7 has the further advantage that it also provides a printing surface which can be utilized for product information or advertising. The sticker 7 shown in FIG. 3 may be of any desired size, as long as it covers the trough 4 and the retaining depressions 36 to a sufficient extent. It is also possible for this sticker 7 to be of considerably larger configuration; its front side may thus be extended as far as the bottom edge of the front part 33 of the lid part 3.

FIG. 4 illustrates a further exemplary embodiment of the egg box 1 according to the invention. The figure illustrates three egg boxes 1, 1′, 1″ which are in clamping-type interconnection with one another. Also illustrated is a further egg box 1*, which is not in clamping-type interconnection with the rest of the egg boxes. As can be seen from FIG. 4 or, in detail, also from FIG. 2, the bottom part 2 of the egg packaging 1 has a clamping elevation 5 at the respective bottom ends of the shaped depressions 21. This clamping elevation is designed as an encircling border. The retaining depressions 36 are formed on the lid part 3 so as to function as clamping openings 6. The dimensions of the clamping elevations 5 and clamping openings 6 are coordinated with one another such that the clamping elevations 5 can be accommodated in a force-fitting manner in the clamping openings 6. Since the retaining depressions 36 have the same spacing between one another as the shaped depressions 21 with their clamping elevations 5, it is possible for a plurality of egg boxes 1, 1′ to be connected to one another with clamping action such that they are offset in relation to one another. It is expedient here for the top edge 30 of the lid part 3 to be drawn in to such an extent that its spacing from the nearest clamping opening 6 is smaller than the spacing of the clamping elevations 5 from one another. This ensures that, in the case of one egg box 1 being mounted in an offset manner on another box 1′, none of the shaped elevations 5 collides with the top part 31 of the lid part. A reliable clamping fit is achieved as a result.

The offset arrangement of the clamping elevations 5 and of the clamping opening 6 further results in it not being possible for egg boxes 1, 1* which are stacked precisely one above the other to get stuck together. This can be seen in the top part of FIG. 4. This has the advantage that filled egg boxes, which are usually stacked directly one above the other for storage or sales purposes, cannot become stuck to one another. This avoids, in a simple but effective manner, the situation where, when the uppermost egg box 1′ is removed, an egg box 1 located therebeneath, or an entire stack of egg boxes, is accidentally also moved along therewith, which could result in the stack toppling over and thus in the eggs being damaged.

The offset arrangement also has the advantage that, with egg boxes 1, 1′ stacked precisely one upon the other, the clamping elevations 5 rest in each case on the top part 31 rather than being located over clamping openings 6, which would result in them having to be borne by the sticker 7. This counteracts the risk of the sticker 7 being damaged due to overloading.

As can further be seen from FIG. 4, it is also correspondingly possible for a plurality of egg boxes 1, 1″ to be connected to one another at a corner. This makes the construction of corner structures possible.

The clamping elevations 5 on the underside and the clamping openings 6 on the top side allow the egg boxes 1 to be put to a second use as clamping-type building blocks. Since they are available cost-effectively and have comparatively large dimensions, they are suitable as a toy for children of different ages. Using the egg boxes as clamping-type building blocks, comparatively large structures, for example toy houses or toy castles, can be constructed rapidly and cost-effectively.

1. A foodstuffs packaging unit, comprising a bottom part having a row of shaped depressions formed therein for accommodating separate articles, and a shaped lid part, which is arranged for swing action on the bottom part and, in a closed state, bounds an interior together with the bottom part, and has a trough formed therein that is open in an upward direction and has dimensions for accommodating at least one of the separate articles,
the lid part comprising a cover that closes off the trough in the upward direction, the trough having a depth that is not greater than a maximum nesting height of the foodstuffs packaging and that is configured in combination with the cover to prevent at least one of the separate articles from dropping out of the foodstuffs packaging.

2. The foodstuffs packaging unit according to claim 1, wherein the cover is a sticker.

3. The foodstuffs packaging unit according to claim 1 or 2, wherein the cover is pulled around opposing edges of the lid part.

4. The foodstuffs packaging unit according to claim 1 or 2, wherein the lid part is provided with retaining depressions connected to the trough.

5. The foodstuffs packaging unit according to claim 4, wherein the trough and the retaining depressions have approximately the same depth.

6. The foodstuffs packaging unit according to claim 4, wherein the retaining depressions have a depth which is not greater than a maximum nesting height of the foodstuffs packaging.

7. The foodstuffs packaging unit according to claim 4, wherein the retaining depressions are offset laterally in relation to the shaped depressions.

8. The foodstuffs packaging unit according to claim 4, wherein one or more of the retaining depressions have an indent on their floor floors.

9. The foodstuffs packaging unit according to claim 1 or 2, wherein the bottom part and the lid part are provided with complementary clamping elevations and clamping openings.

10. The foodstuffs packaging unit according to claim 9, wherein the clamping elevations and the clamping openings are respectively no higher or deeper than a maximum nesting height of 4 to 15 mm.

11. The foodstuffs packaging unit according to claim 9, wherein the clamping openings are offset approximately centrally over two adjacent clamping elevations in a row.

12. The foodstuffs packaging unit according to claim 9, wherein the the lid part has a top edge configured such that its spacing from the nearest clamping opening is, at most, equal to the free spacing between adjacent clamping elevations.

13. The foodstuffs packaging unit according to claim 9, wherein the clamping elevations and the clamping openings have a conicity of 2° to 15°.

14. The foodstuffs packaging unit according to claim 9, wherein at least six clamping elevations arranged in a double row are provided.

15. The foodstuffs packaging unit according to claim 9, wherein the retaining depressions are designed as the clamping openings and the shaped depressions are designed as clamping elevations.

16. The foodstuffs packaging unit according to claim 4, wherein the clamping elevations and the clamping openings are respectively no higher or deeper than a maximum nesting height of 4 to 15 mm.

17. The foodstuffs packaging unit according to claim 4, wherein the clamping elevations and the clamping openings are respectively no higher or deeper than a maximum nesting height of 7 to 9 mm.

18. The foodstuffs packaging unit according to claim 9, wherein the clamping elevations and the clamping openings are respectively no higher or deeper than a maximum nesting height of 7 to 9 mm.

19. The foodstuffs packaging unit according to claim 10, wherein the clamping elevations and the clamping openings have a conicity of 20 to 15°.

20. The foodstuffs packaging unit according to claim 9, wherein the clamping elevations and the clamping openings have a conicity of 7° to 9°.

21. The foodstuffs packaging unit according to claim 10, wherein the clamping elevations and the clamping openings have a conicity of 7° to 9°.

22. The foodstuffs packaging unit according to claim 10, wherein the clamping elevations and the clamping openings are respectively no higher or deeper than a maximum nesting height of 7 to 9 mm.

23. The foodstuffs packaging unit according to claim 10, wherein at least six clamping elevations arranged in a double row are provided.

24. The foodstuffs packaging unit according to claim 10, wherein the retaining depressions are designed as the clamping openings and the shaped depressions are designed as clamping elevations.

25. The foodstuffs packaging unit according to claim 1, wherein the foodstuffs packaging unit is configured for packaging eggs.

26. The foodstuffs packaging unit according to claim 9, wherein the foodstuffs packaging unit is configured for packaging eggs.
